(19) United States
(12) Patent Application Publication
(10) Pub. No.: US 2021/0102685 A1
(43) Pub. Date: Apr. 8, 2021

(54) REFPLECTIVE LIGHTING

(71) Applicant: Research & Design Innovations, LLC, Branford, CT (US)

(72) Inventors: Donald Terry Allen, Madison, CT (US); Kevin Hannula, Bloomington, IN (US)

(21) Appl. No.: 17/063,252

(22) Filed: Oct. 5, 2020

Related U.S. Application Data
(60) Provisional application No. 62/910,768, filed on Oct. 4, 2019.
(60) Provisional application No. 62/930,233, filed on Nov. 4, 2019.

(51) Int. Cl. F21V 7/00; F21V 7/04

(52) U.S. Cl. CPC F21V 7/0075; F21Y 2103/00; F21V 7/043

(57) ABSTRACT

An apparatus for providing reflective lighting. The apparatus includes a light source for providing an initial light wave having first light wave characteristics and a surface having a reflective material which alters the characteristics of the light emanating from the light source, providing a secondary light having second light wave characteristics. The first light wave may not be visible to the human eye and the secondary light may be visible to the human eye. The first light wave may include invisible frequencies which are converted to visible light frequencies upon striking the reflective material.

### BACKGROUND OF THE INVENTION

### 1. Field of the Invention

The present invention relates to lighting which is provided by a point source and directed to a reflective material for illumination of a specific area or article.

### 2. Description of Related Art

Fluorescent lamps generate light by passing electricity through a tube filled with inert gas and a small amount of mercury. When energized, mercury atoms emit energy in the form of light photons. They emit some visible light photons, but mostly they emit photons in the ultraviolet (UV) wavelength range. Because UV light waves are invisible to the human eye, fluorescent lamps have to convert this energy into visible light. They do this with a phosphor coating on the tube. A black light is a fluorescent lamp which omits the phosphor coating to allow the UV light to pass through the glass tube.

Phosphors are substances that give off light—or fluoresce—when they are exposed to light. When a photon hits a phosphor atom, one of the phosphor's electrons jumps to a higher energy level, causing the atom to vibrate and create heat. When the electron falls back to its normal level, it releases energy in the form of another photon. This photon has less energy than the original photon, because some energy was lost as heat. In a fluorescent lamp, the emitted light is in the visible spectrum—the phosphor gives off white light we can see.

There are several differences between a fluorescent black light and an incandescent black light. A tube black light is similar to a fluorescent lamp but has a different phosphor coating. This coating absorbs harmful shortwave UV-B and UV-C light and emits UV-A light (in the same basic way the phosphor in a fluorescent lamp absorbs UV light and emits visible light). The “black” glass tube itself blocks most visible light, so in the end only benign long-wave UV-A light, along with some blue and violet visible light, passes through. An incandescent black light bulb is similar to a normal household light bulb, but it uses light filters to absorb the light from the heated filament. The filters on or within the glass absorb substantially everything except the infrared and UV-A light. A small amount of visible light may be emitted from the bulb. In both of these light designs, the emitted UV light reacts with various external phosphors in exactly the same way as the UV light inside a fluorescent lamp reacts with the phosphor coating. The external phosphors glow as long as the UV light is shining on them. There are lots of natural phosphors, in your teeth and fingernails, among other things. There also a lot of phosphors in manmade material, including television screens and some paints, fabric and plastics. Most fluorescent colored things, such as highlighters, contain phosphors, and can be found in all glow-in-the-dark products. Black light paint may glow different colors, depending on the paint formula.

### SUMMARY OF THE INVENTION

Bearing in mind the problems and deficiencies of the prior art, it is therefore an object of the present invention to provide reflective lighting which includes a reflective material applied to a surface which alters the light properties of the light source.

It is another object of the present invention to provide reflective lighting which uses a surface having a phosphorous material to provide lighting from a point source a distance away from the surface.

It is still another object of the present invention to provide a system which changes the properties of a light wave emitted from a light source when the light wave strikes a reflective material.

Still other objects and advantages of the invention will in part be obvious and will in part be apparent from the specification.

The present invention provides a system for illuminating an area comprising a reflective material applied to a surface and a light source providing a first light wavelength which visibly illuminates the reflective material when the first light wavelength strikes the reflective material. The reflective material may be applied as a paint. The reflective material may be a flat material having an adhesive backing. The reflective material may be mountable to a surface. The reflective material may be integrated into a surface or covering. The reflective material may be integrated into safety clothing. The reflective material may contain a phosphorous material. The reflective material may in a fluid wherein the fluid is confined in a container. The container may include at least one transparent or semi-transparent portion wherein the first light wavelength passes through the at least one transparent or semi-transparent portion to visibly illuminate the reflective material in the fluid. The light source may be a black light or an LED or may be a black light LED. The light source may produce light the ultraviolet wavelength range. The light source may have a variable wavelength output and changing the wavelength of the variable wavelength output changes the light wavelength reflected from the reflective material

Another aspect the present invention teaches an apparatus for providing reflective lighting comprising a light source for providing an initial light wave having first light wave characteristics and a surface having a reflective material which alters the characteristics of the light emanating from the light source, providing a secondary light having second light wave characteristics. The first light wave may not be visible to the human eye and the secondary light may be visible to the human eye. The first light wave may include invisible frequencies which are converted to visible light frequencies upon striking the reflective material.

Another aspect the present invention provides a method for using reflective lighting. The method comprises providing a light source for providing an initial light wave having first light wave characteristics and a surface having a reflective material which alters the characteristics of the light emanating from the light source and providing a secondary light having second light wave characteristics. The method includes supplying power to the light source, producing the initial light wave and allowing the initial light wave to strike the reflective material wherein the reflective material changes the characteristics of the initial light wave and producing the secondary light having the second light wave characteristics.

Another aspect the present invention provides a method for installing reflective lighting comprising providing a light source for providing an initial light wave having first light wave characteristics. The method includes applying a reflective material which alters the characteristics of the light emanating from the light source to a surface and pointing the light source toward the reflective material such that when power is supplied to the light source, the initial light wave will strike the reflective material

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a side elevational view of a first embodiment of the reflective lighting according to the present invention.

FIG. 2 is a side elevational view of a second embodiment of the reflective lighting according to the present invention.

FIG. 3 is a side elevational view of a third embodiment of the reflective lighting according to the present invention.

FIG. 4 is a side elevational view of a fourth embodiment of the reflective lighting according to the present invention.

FIG. 5 is a perspective view of reflective lighting for illuminating a sign, symbol or geographical shape.

FIG. 6 is a perspective view of a pontoon boat having pontoon tubes illuminated with the reflective lighting according to the present invention.

FIG. 7 is a perspective view of a marine vessel having a covering illuminated with the reflective lighting according to the present invention.

FIG. 8 is a perspective view of a dashboard panel having gauges illuminated with the reflective lighting according to the present invention

### DESCRIPTION OF THE EMBODIMENT(S)

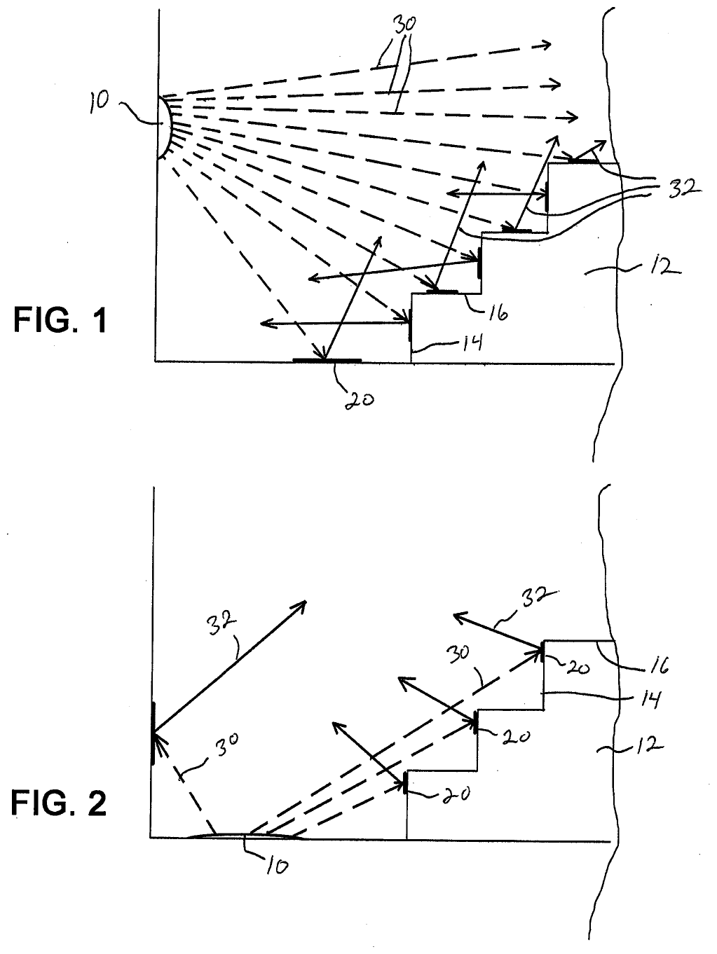

In describing the embodiment of the present invention, reference will be made herein to FIGS. 1-8 of the drawings in which like numerals refer to like features of the invention.

The power source may be a rechargeable battery powered may be a solar panel. The light source, when illuminated directs a visible or invisible light to a reflective material which, when struck by the visible or invisible light, illuminates with a visible light. The reflective material may alter the light frequency such as making an invisible light perceivable or making a black light glow or fluoresce. The reflective material may be a coating applied to a vessel surface or adhesive strip having specific reflective properties, the adhesive strip attachable to surface. The reflective material may have a pattern or shape which may take the form of a lighting band, lighting strip, circular, square or other geometrical shape. A neon light pattern may also be produced in this method. Another embodiment of the invention would include fluorescent black light carpet to be illuminated by a distant black light source. Still another embodiment of the invention would include fluorescent black light upholstery to be illuminated by a distant black light source. The upholstery may be the outer covering of a chair, couch or other piece of furniture.

In the following examples, when referring to the light source, including light sources 10, 110, 210, 310, 410, 510 and 610 shown in the drawings, the light source is of a frequency which changes when reflected off the reflective material. Preferably the light produces directly from the light source contains light frequencies which provide little or no visible light while the light reflected from the reflective material is of frequency combinations which are more visible. The indirect lighting as shown in FIGS. 1 and 2 allows a light source 10 to be installed in a convenient location on the marine vessel while allowing more leeway on the location to which the light source 10 is directed. For example, a spotlight may be attached to a vessel inside wall where wiring may be easily accessible. The spotlight may produce initial light waves 30 and may be directed to a reflective material 20 on adjacent steps 12 where attaching direct lighting may be virtually impossible. The spotlight shines the light on the reflective material 20 on the adjacent steps 12, allowing the reflective material 20 to emit a secondary light 32 having different light characteristics than the initial light 30 and providing illumination of the steps. The reflective material 20 may be on the tread 16 or on the riser 14. The reflective material 20 may contain phosphors that convert UV light into white light and the light source may primarily emit UV light. An example of this mode of operation is a black light shining on the reflective material containing phosphors. Another advantage is that the visible light which is normally emitted from a light source is minimal and only the reflective material would provide the visible lighting, allowing the light source to be located in a place where visible light would normally be annoying, especially in low lighting conditions.

In another embodiment, a reflective lighting surface material may be produced by a manufacturer or on site where the surface material may be constructed or used. Surface materials include but are not limited to fiberglass, concrete, textiles, plastics and metal. A surface material may also include a liquid material where the liquid material may be contained within a transparent frame. Artwork may even be produced using this medium and other mediums discussed herein. The surface material may include at least one element within the surface material having a phosphorous material applied, mixed, or added. In an example using fiberglass as the surface material, a phosphorous material may be added to the fiberglass resin or may be applied to the fiberglass cloth. The final visual effect may be dramatically different depending on which material of the finished fiberglass the phosphorous material is used. In an example using concrete, the phosphorous material may be mixed with the concrete which forms the block, wall or concrete surface. Alternately, the phosphorus material may be mixed in the mortar connecting two or more concrete objects.

Phosphorous materials applied to one element of a multi-element material may provide unique visual effects. Any material which uses a temporarily liquid binder and inner core fibers may benefit from the combination of using a light altering material to reflect a light source.

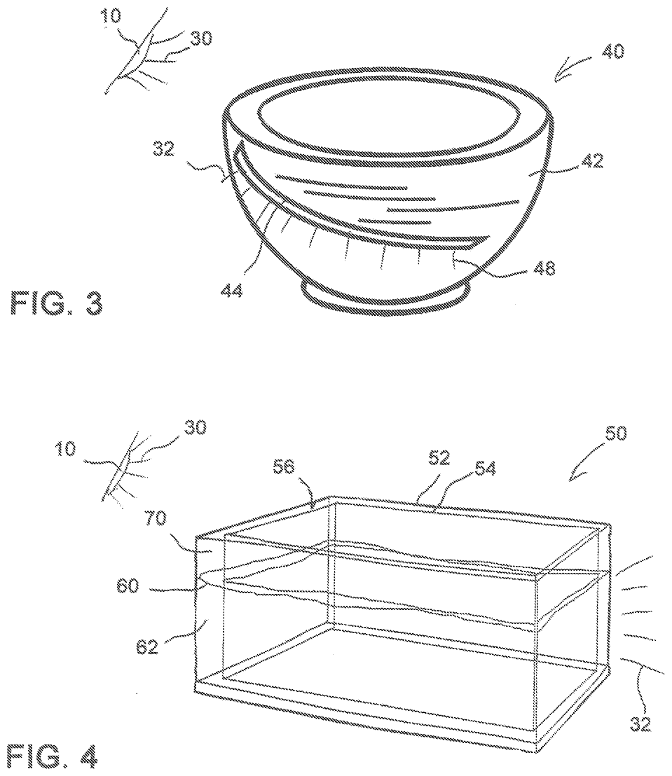

In the example shown in FIG. 3, a bowl 40 is made from a transparent or translucent base material 42 such as glass, plastic or the like. A trim material 44 includes a light altering material which alters the appearance of the light 30 from the initial source 10. The trim material 44 is bound within or is inserted into or fabricated along with the base material 42. In a finished product in use, the light 30 from the light source 10 would penetrate the base material 42, strike the light altering trim material 44 where the visual appearance of the reflected light 32 is changed from the visual appearance of the initial light 30, and be reflected to an area adjacent the bowl or be reflected directly to the person in visual sight of the bowl. Likewise, a table or other furnishing may include a transparent or semi-transparent portion which contains a fluid having a reflective material. The initial light 30 would penetrate the transparent or semi-transparent portion to illuminate the reflective material. The light reflected from the reflective material would then be visible through the transparent or semi-transparent portion or through another portion of the table or other furnishing.

In another example, components or structures within a marine vessel engine room may include reflective material which provides visible light when exposed to a source light, either an initially visible source light or an initially invisible source light. Alternately the reflective material may convert a visible light source of one wavelength combination to a visible light of a second wavelength combination.

In another example shown in FIG. 4, a transparent container 50 has a cavity 56 between outer and inner transparent walls 52, 54 for the storage of a liquid 62 having a light altering material. In a finished product in use, the light 30 from the light source 10 would penetrate the transparent container outer transparent wall 52, strike the light altering liquid 62 where the visual appearance of the light is changed, and be reflected to an area adjacent the container 50 or be reflected directly to the person in visual sight of the container. The top surface 60 of liquid 62 may be at the top of the container 50 or may be at a lower level as shown in FIG. 4.

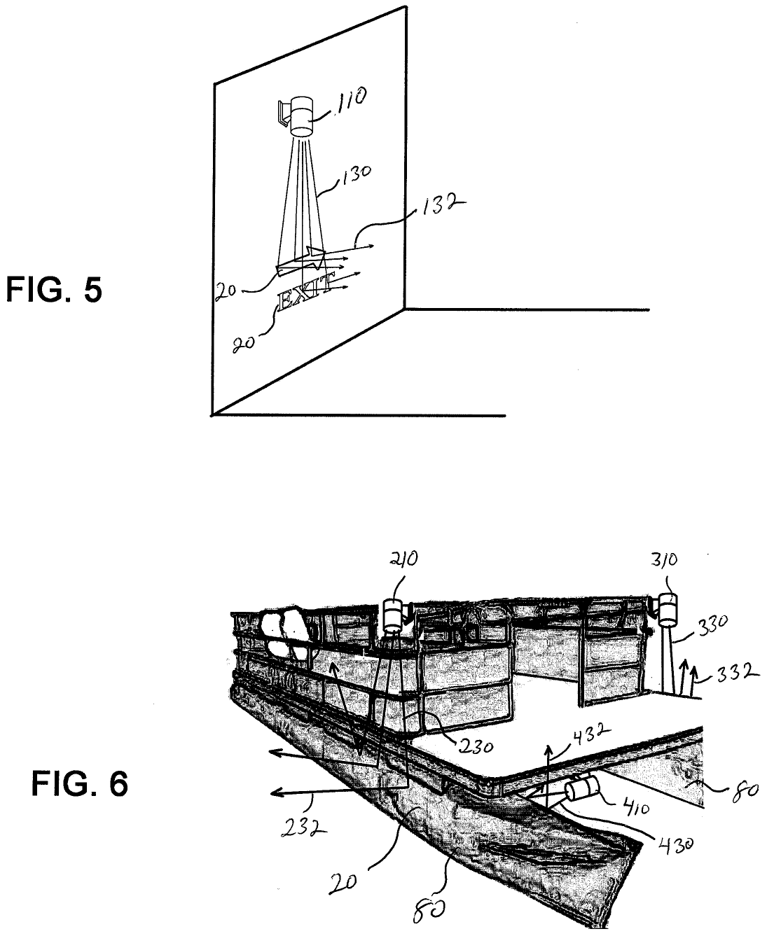

In another example shown in FIG. 5, a reflective lighting surface material 20 may be incorporated to produce lines, arrows, and other geographic shapes used for safety. The geographical shapes may be disposed on stairs, stairways, hallways or other place which requires route or warning messages. The geographical shapes may be on routes to board or exit a boat, RV or other area requiring illuminated graphics. The reflective lighting surface material 20 may also be used as logos or decorations. The present invention allows for the illuminated articles to only show up when used in conjunction with the black light or other light which may be altered by the reflective lighting surface material. This gives the room, boat, RV or other area a traditional look during daylight hours with the area easily transformed at night when the light source is powered.

In another example shown in FIG. 6, pontoon tubes 80 include the reflective material 20 either on substantially the entire visible surface or a portion of the surface with at least one light source 210, 310, 410 directed at the reflective material from a distance. The combination of the light source and reflective material will lower the cost of installing pontoon lighting directly on the pontoon tubes, especially with reduced installation time compared to currently available products.

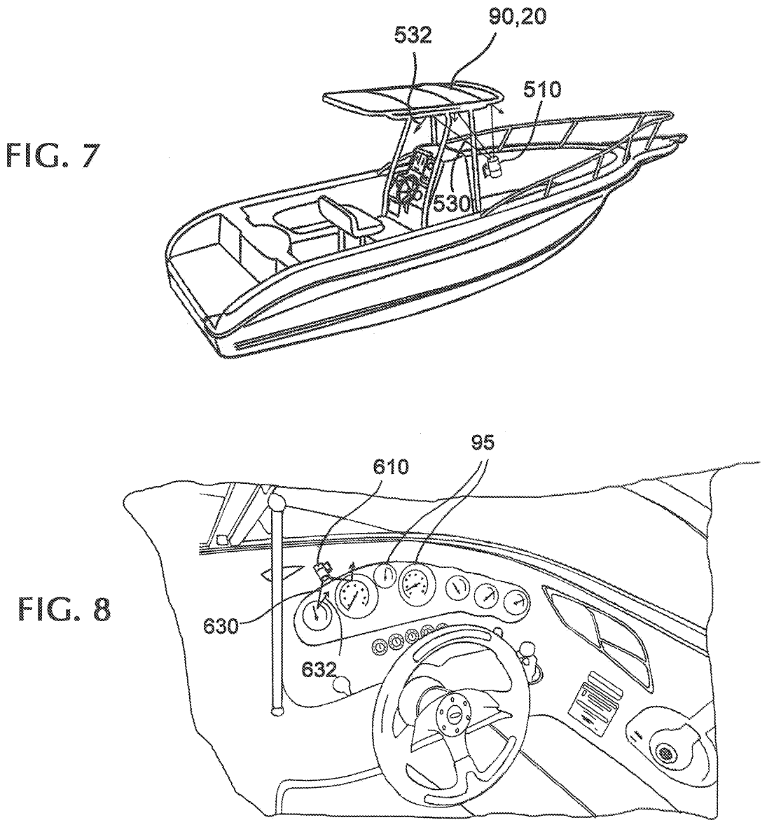

Being able to incorporate or blend the reflective chemicals into fabrics, fiberglass, wood, metals or other composites allows versatility of where it can be used by the manufacturer. Being able to incorporate the reflective chemical also makes it easier to mold into forms especially in fiberglass. With canvas and woven fiber products we can illuminate the inside of storage areas, vessel tops and covers, umbrella shapes or Bimini tops. The reflective chemical can even incorporate the products into use with upholstery, i.e., all types of bench or chair designed products and other seating items as well as tables, and floors. FIG. 7 shows the reflective material 20 incorporated into the marine vessel covering fabric with a light source 510 producing a light wave 530 having a first frequency directed to the covering 90 and producing a reflective light wave 532 having a second frequency, preferably more visible than the first frequency.

As shown in FIG. 8, the dashboard gauges 95 on a boat may benefit from the reflective lighting described herein. A light source 610 produces a light wave 630 having a first frequency directed to the dashboard gauges 95 and producing a reflective light wave 632 having a second frequency, preferably more visible than the first frequency.

The reflective lighting may be incorporated in beverage holders and speakers to soften textures. This takes the high cost out for the manufacturer and makes the use of the end product by the consumer easier to afford and use. In beverage holders the reflective part of the holder can produce reflective lighting anywhere on or inside the cup, or both regardless of the material of the beverage holder. Speakers may be illuminated with this reflective lighting, the speakers illuminated internally, externally or both.

Thus, the present invention provides one or more of the following advantages:
to provide reflective lighting which includes a reflective material applied to a surface which alters the light properties of the light source;
to provide reflective lighting which uses a surface having a phosphorous material to provide lighting from a point source a distance away from the surface; and
to provide a system which changes the properties of a light wave emitted from a light source when the light wave strikes a reflective material.

While the present invention has been particularly described, in conjunction with one or more specific embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A system for illuminating an area comprising:
a reflective material applied to a surface; and
a light source providing a first substantially invisible light wavelength which visibly illuminates the reflective material when the first light wavelength strikes the reflective material;
wherein the reflective material alters the first light wavelength and provides visible light to an area adjacent the surface or to the surface which includes the reflective material.

2. The system of claim 1 wherein the reflective material is applied as a paint.

3. The system of claim 1 wherein the reflective material includes a substantially flat base having an adhesive backing.

4. The system of claim 1 wherein the reflective material is mountable to a surface.

5. The system of claim 1 wherein the reflective material is integrated into a surface or covering.

6. The system of claim 1 wherein the reflective material is integrated into safety clothing.

7. The system of claim 1 wherein the reflective material contains a phosphorous material.

8. The system of claim 1 wherein the reflective material is in a fluid and the fluid is confined in a container.

9. The system of claim 8 wherein the container includes at least one transparent or semi-transparent portion wherein the first light wavelength passes through the at least one transparent or semi-transparent portion to visibly illuminate the reflective material in the fluid.

10. The system of claim 1 wherein the light source is a black light.

11. The system of claim 11 wherein the light source is an LED.

12. The system of claim 1 wherein the light source produces light in the ultraviolet wavelength range.

13. The system of claim 1 wherein the light source has a variable wavelength output and changing the wavelength of the variable wavelength output changes the light wavelength reflected from the reflective material.

14. An apparatus for providing reflective lighting comprising:
a light source for providing an initial light wave having first light wave characteristics; and
a surface having a reflective material which alters the characteristics of the light emanating from the light source, providing a secondary light having second light wave characteristics.

15. The apparatus of claim 14 wherein the first light wave is invisible to the human eye and the secondary light is visible to the human eye.

16. The apparatus of claim 14 wherein the light source includes additional light frequencies which are visible to the human eye.

17. The apparatus of claim 14 wherein the light source is a black light.

18. The apparatus of claim 14 wherein the reflective material is disposed on a symbol or geometrical shape.

19. The apparatus of claim 14 wherein the reflective material is disposed on pontoon tubes and the light source is disposed on the railing, deck or under the deck.

20. The apparatus of claim 14 wherein the reflective material is incorporated in a bimini top or other covering of a marine vessel.

21. The apparatus of claim 14 wherein the reflective material is disposed at least one dashboard gauge and the light source is disposed above or inside the dashboard.

22. A method for using reflective lighting comprising:
providing a light source for providing an initial light wave having first light wave characteristics and a surface having a reflective material which alters the characteristics of the light emanating from the light source, providing a secondary light having second light wave characteristics;
supplying power to the light source, producing the initial light wave;
allowing the initial light wave to strike the reflective material, the reflective material changing the characteristics of the initial light wave and producing the secondary light having the second light wave characteristics.
